(19) United States
(12) Patent Application Publication
(10) Pub. No.: US 2018/0243165 A1
(43) Pub. Date: Aug. 30, 2018

(54) Spa Tub and Cabinet Construction System

(71) Applicant: Sundance Spas, Inc., Chino, CA (US)

(72) Inventors: Brian Koops, Murrieta, CA (US); John M. Clark, Huntington Beach, CA (US); Matthew L. Breithaupt, Aguanga, CA (US); Adrian Alfaro, Menifee, CA (US)

(21) Appl. No.: 15/903,650

(22) Filed: Feb. 23, 2018

Related U.S. Application Data
(60) Provisional application No. 62/463,767, filed on Feb. 27, 2017.

(51) Int. Cl. A61H 33/00

(52) U.S. Cl. CPC A61H 33/6005; A61H 33/0091

(57) ABSTRACT

A spa assembly includes a base pan; a frame assembly; and a spa shell supported on the base pan and the frame assembly. The spa shell includes a bottom and at least one side defining an open internal volume, an interior surface oriented toward the open internal volume, an opposing exterior surface, and a rim surrounding the at least one side, the rim defining an internal cavity. The exterior surface of the bottom of the spa shell has a foam material applied thereon. The foam material applied to the bottom of the spa shell and the base pan comprise corresponding interlocking features that align the spa shell within the base pan. The internal cavity of the rim has the foam material applied thereto. The foam material in the rim has a groove formed therein, the groove being configured to receive the frame assembly.

### CROSS REFERENCE TO RELATED APPLICATION

The present application claims priority to U.S. Provisional Patent Application No. 62/463,767, filed on Feb. 27, 2017, which is incorporated herein by reference in its entirety.

### BACKGROUND OF THE INVENTION

### Field of the Invention

The invention relates to a spa tub and cabinet assembly and, in particular, a spa tub and cabinet assembly that incorporates a base pan, an indexed frame assembly, and a system for assembling the frame and the spa shell on the base pan.

### Description of Related Art

Typical spa tubs are constructed from a fiberglass or plastic shell forming the spa tub basin, which is supported on a surrounding cabinet. The cabinet is typically constructed from a wooden frame. Decorative panels and finishes are assembled on the frame to define the cabinet structure around the spa shell. Manufacturing the spa cabinet in this manner is a substantially labor-intensive process since the wooden frame must be assembled by hand. Large tolerances in the components are required to accommodate deviation in the manufacturing and molding processes.

Shipping and installation of the completed spa is also time and labor-intensive because the weight of the spa shell may not be evenly distributed on the frame, causing deflection of the frame.

### SUMMARY OF THE INVENTION

According to an example of the present disclosure, a spa assembly is provided. The spa assembly includes a base pan; at least one support member connected to and extending upward from the base pan; and a spa shell supported on the base pan and the at least one support member, the spa shell including a bottom and at least one side defining an open internal volume of the spa shell, an interior surface oriented toward the open internal volume, and an opposing exterior surface. The bottom of the spa shell and the base pan comprise corresponding interlocking features configured to align the spa shell within the base pan.

According to another example of the present disclosure, a spa assembly is provided. The spa assembly includes a base pan; at least one support member connected to and extending upward from the base pan; and a spa shell supported on the base pan and the at least one support member, the spa shell including a bottom and at least one side defining an open internal volume of the spa shell, an interior surface oriented toward the open internal volume, an opposing exterior surface, and a rim surrounding the at least one side. The rim has a recess formed therein, the recess being configured to receive a top of the at least one support member.

According to another example of the present disclosure, a spa assembly is provided. The spa, assembly includes a base pan and a frame assembly. The frame assembly includes a plurality of support members connected to the base pan, and a top rail connected to the support members and extending around a perimeter of the spa assembly. The spa assembly further includes a spa shell supported on the base pan and the frame assembly, the spa shell including a bottom and at least one side defining an open internal volume of the spa shell, an interior surface oriented toward the open internal volume, and an opposing exterior surface; a plurality of insulative panels connected to the frame assembly, wherein the plurality of insulative panels encloses the spa assembly around the at least one side of the spa shell; and a plurality of clips configured to connect the plurality of insulative panels to the plurality of support members.

According to another example of the present disclosure, a spa assembly is provided. The spa assembly incudes a base pan; at least one support member connected to and extending upward from the base pan; a spa shell supported on the base pan and the at least one support member, the spa shell including a bottom and at least one side defining an open internal volume of the spa shell, an interior surface oriented toward the open internal volume, and an opposing exterior surface; and at least one pallet member. A bottom surface of the base pan has at least one recess formed therein, the at least one recess being configured to receive the at least one pallet member therein.

According to another example of the present disclosure, a method of assembling a spa is provided. The method includes providing a base pan, at least one support member, and a spa shell, wherein the base pan includes interlocking features and the spa shell includes a bottom and at least one side defining an open internal volume of the spa shell, an interior surface oriented toward the open internal volume, an opposing exterior surface, and a rim surrounding the at least one side, the rim defining an internal cavity; connecting the at least one support member to the base pan such that the at least one support member extends upward from the base pan; applying a foam material to at least a portion of the exterior surface of the bottom of the spa shell; forming interlocking features in the foam material applied to the bottom of the spa shell, the interlocking features in the foam material corresponding to the interlocking features of the base pan; applying a foam material to the internal cavity defined by the rim; forming a recess in the foam material in the internal cavity of the rim; and installing the spa shell on the base pan and the at least one support member such that the spa shell is supported by the base pan and the at least one support member. The installing step includes engaging the interlocking features of the base pan with the interlocking features in the foam material applied to the bottom of the spa shell to align the spa shell within the base pan and engaging a top of the at least one support member within the recess in the foam material in the internal cavity of the rim.

These and other features and characteristics of the present invention, as well as the methods of operation and functions of the related elements of structures, and the combination of parts and economies of manufacture, will become more apparent upon consideration of the following description and with reference to the accompanying drawings, all of which form a part of this specification, wherein like reference numerals designate corresponding parts in the various figures. It is to be expressly understood, however, that the drawings are for the purpose of illustration and description only, and are not intended as a definition of the limits of the invention. As used in the specification and the claims, the singular form of “an”, and “the” include plural referents unless the context clearly dictates otherwise.

### BRIEF DESCRIPTION OF THE DRAWINGS

FIG. 1 is an exploded view of a spa assembly in accordance with an embodiment of the present disclosure;

FIG. 2 is a perspective view of an assembled base pan, frame assembly, and mounted spa equipment and accessories of the spa assembly of FIG. 1;

FIG. 3 is a front view of the assembled base pan and frame assembly of the spa assembly of FIG. 1;

FIG. 4 is a perspective view of an assembled base pan and frame assembly of the spa assembly of FIG. 1;

FIG. 5 is a perspective view of the base pan of the spa assembly of FIG. 1;

FIG. 6 is an exploded perspective view of a connection between an upright member and the base pan in the spa assembly of FIG. 1;

FIG. 7 is a perspective view of the connection between the upright member and the, base pan in the spa assembly of FIG. 1;

FIG. 8 is an exploded view of a connection between a side member and a corner member of a top rail in the spa assembly of FIG. 1;

FIG. 9 is a perspective view of a connection between an upright member and a side member of the top rail in the spa assembly of FIG. 1;

FIG. 10 is a perspective view of a WiFi bracket and a wire loom hook for locating spa components and accessories on the frame assembly in the spa assembly of FIG. 1;

FIG. 11 is an exploded view of a connection between the bottom of a spa shell and the base pan in the spa assembly of FIG. 1;

FIG. 12 is a perspective view of the bottom of the spa shell of the spa assembly of FIG. 1;

FIG. 13 is a detailed perspective view of the rim of the spa shell of the spa assembly of FIG. 1;

FIG. 14 is a perspective view of the spa assembly of FIG. 1;

FIG. 15 is a perspective view of an assembly of fastening clips to an upright member in the spa assembly of FIG. 1; and

FIG. 16 is a schematic illustrating the various fastening clips in the spa assembly of FIG. 1.

### DETAILED DESCRIPTION OF THE INVENTION

For purposes of the description hereinafter, the terms “end”, “upper”, “lower”, “right”, “left”, “vertical”, “horizontal”, “top”, “bottom” “lateral” “lateral”, “longitudinal”, and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings and described in the following specification are simply exemplary embodiments or aspects of the invention. Hence, specific dimensions and other physical characteristics related to the embodiments or aspects disclosed herein are not to be considered as limiting.

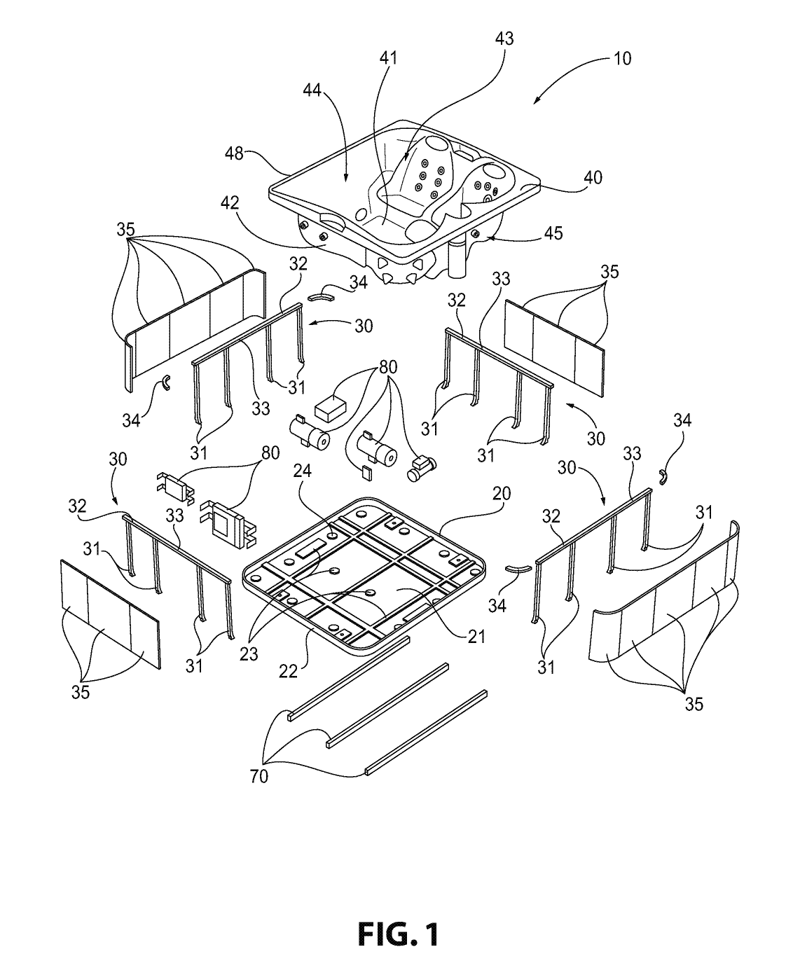

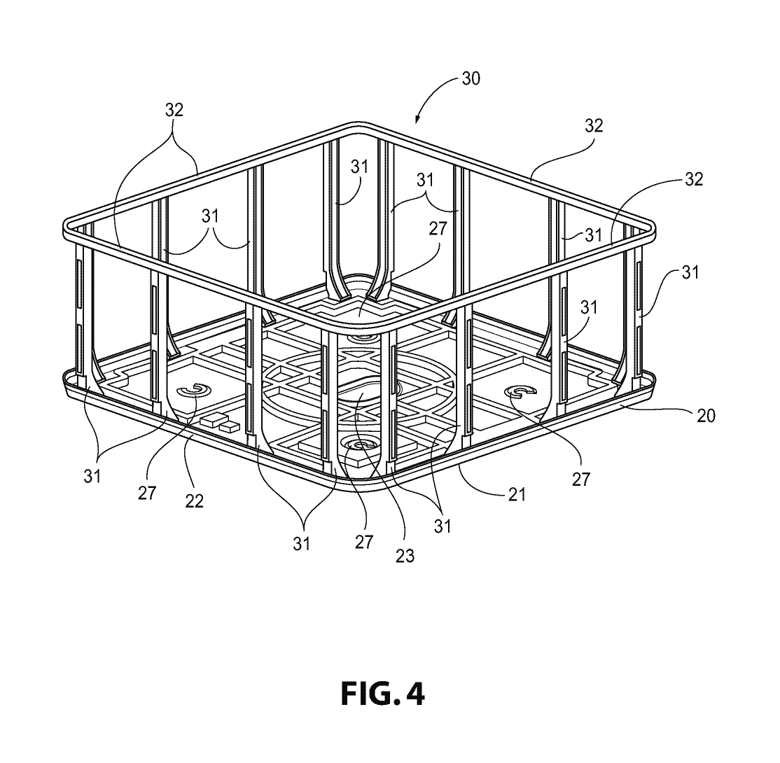

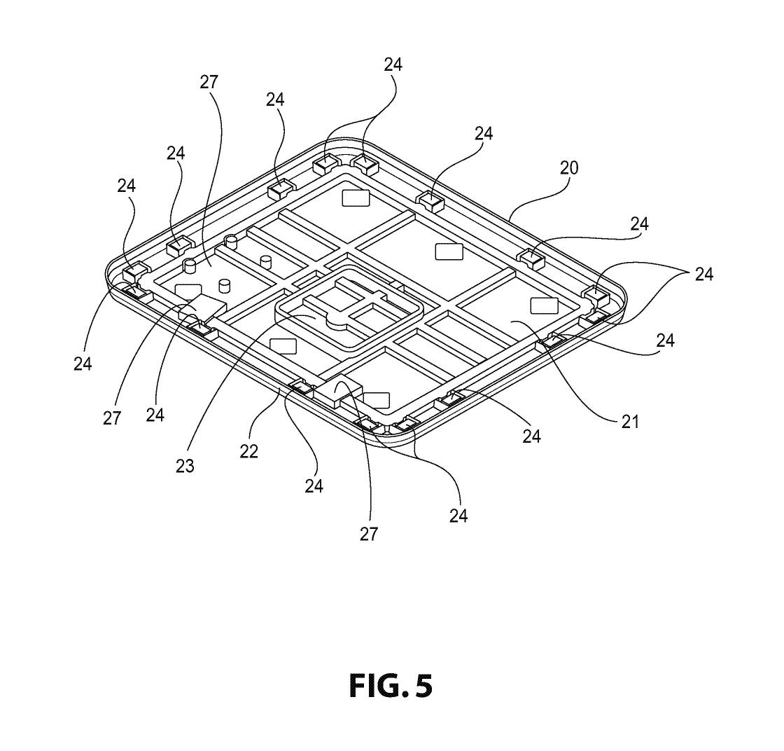

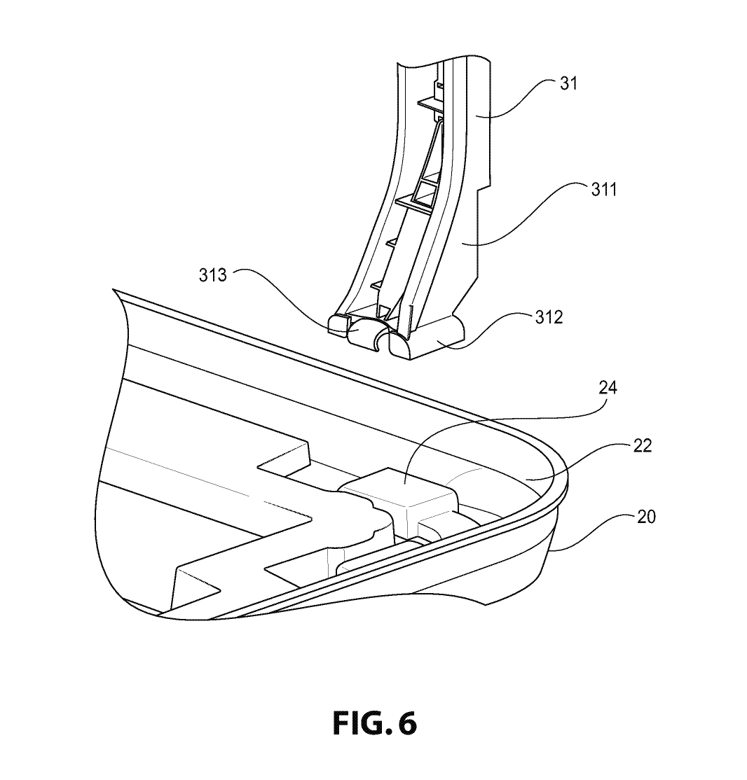

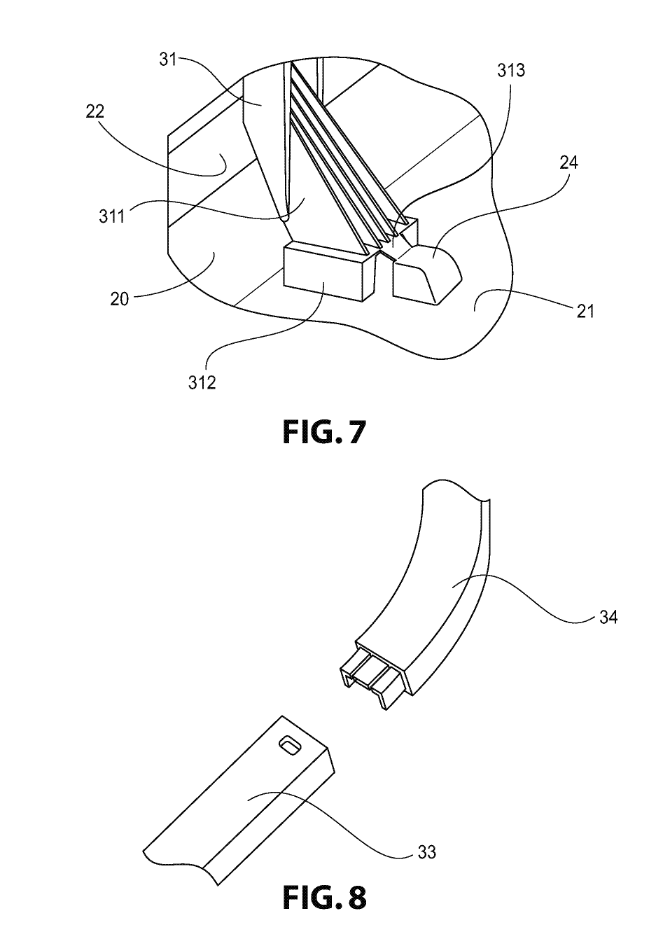

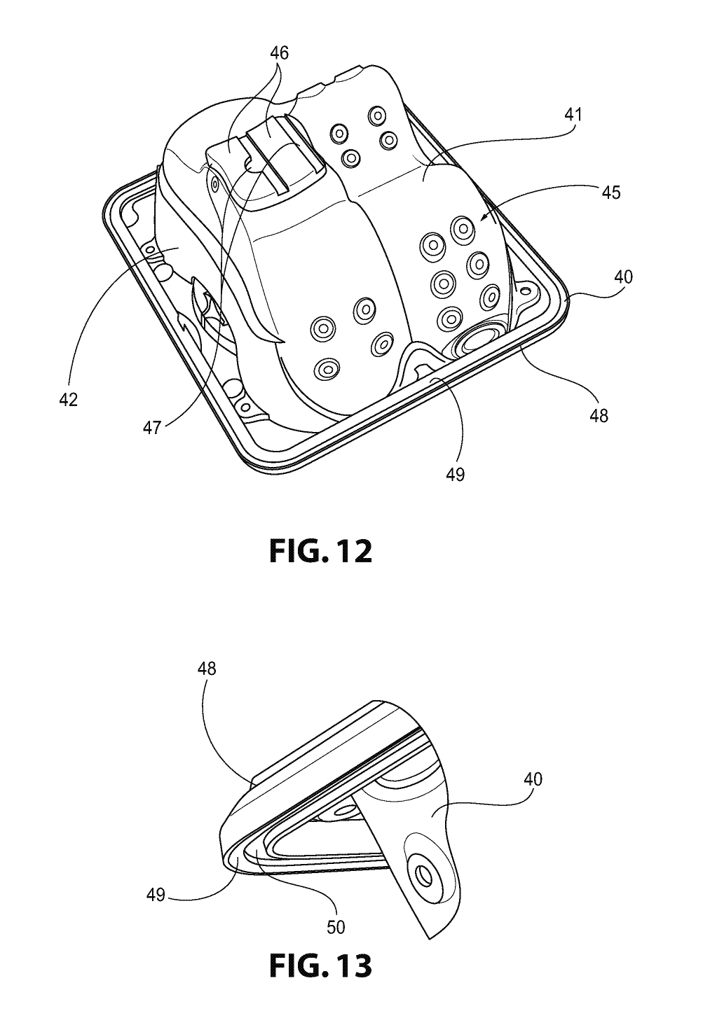

With reference to FIGS. 1-16 and FIGS. 13 and 14 in particular, a spa assembly 10 is shown according to an example of the present disclosure. The spa assembly 10 includes a base pan 20, at least one support member connected to and extending upward from the base pan 20, and a spa shell 40 supported on the base pan 20 and the at least one support member.

As shown in FIGS. 1, 3-5, 11, and 14, the base pan 20 includes a bottom 21 forming the bottom of the spa assembly 10 and an upstanding rim 22 surrounding the bottom 21. According to one example present disclosure, the base pan 20 is manufactured from a polymeric material, in particular acrylonitrile butadiene styrene (ABS), in a vacuum molding process. The bottom 21 of the base pan 20 may be completely sealed. The base pan 20 may have a thickness of 0.25″ (0.64 cm). According to another example of the present disclosure, the base pan 20 is manufactured via a reverse vacuum molding process, which improves the internal feature tolerances of the base pan 20.

As shown in FIGS. 1, 3, and 11-14, the spa shell 40 includes a bottom 41 and at least one side 42, which define an open internal volume 43 of the spa shell 40, an interior surface 44 oriented toward the open internal volume 43, and an opposing exterior surface 45. According to one example of the present disclosure, the spa shell 40 is made from an acrylic backed with a polymer material, in particular ABS material. The thickness of the acrylic material in the spa shell 40 may be 0.125″ (0.32 cm) and the thickness of the ABS material in the spa shell 40 may also be 0.125″ (0.32 cm). The spa shell 40 may be formed according to known techniques and may include features standard to spa, tub basins, such as seats, pillows, waterfalls, jets, speakers, etc. As shown, the spa shell 40 has a substantially rectangular configuration with four sides. It is to be appreciated that the spa shell 40 may be formed in different configurations, such as triangular, circular, elliptical, or other.

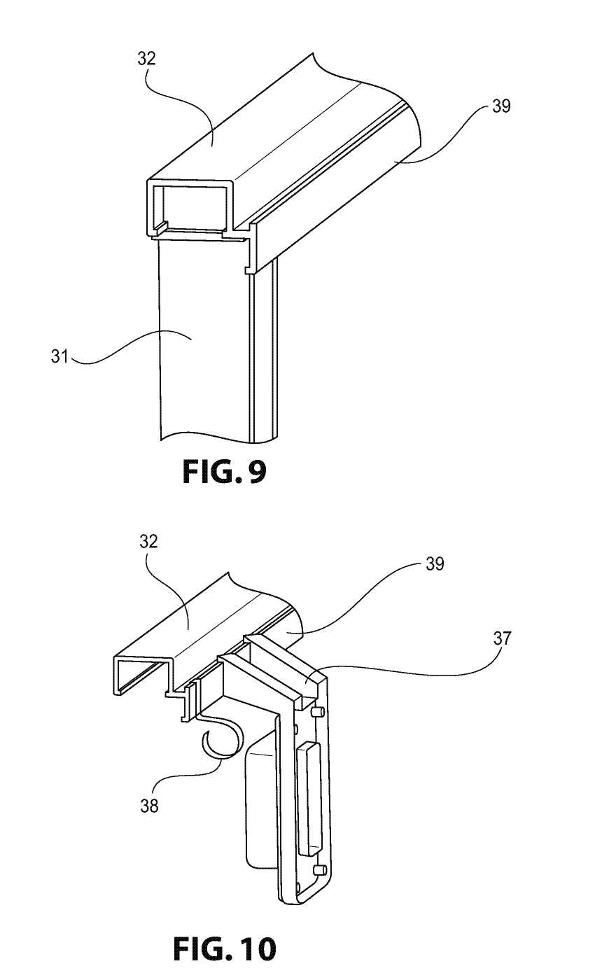

With reference to FIGS. 1-10 and 14, the at least one support member is a frame assembly 30 that includes a plurality of support members 31 connected to and extending from the base pan 20 and a top rail 32 connected to the support members 31 and extending around a perimeter of the spa assembly 10. Preferably, the support members 31 are a one-piece unitary construction. As shown in FIGS. 1-4 and 8-10, the top rail 32 includes an assembly of interconnected sides 33 and corners 34. The sides 33 and corners 34 include fastening features on the ends thereof to allow the pieces 33, 34 to be snapped together to form the top rail 32. As shown in FIGS. 1 and 9, the pieces 33, 34 of the top rail 32 are channel shaped and configured to receive the top ends of the support members 31 such that the pieces 33, 34 of the top rail 32 may be assembled on the support members 31 by snapping the pieces 33, 34 on the top ends of the of the support members 31.

As shown in FIGS. 1 and 5-7, the base pan 20 includes a plurality of anchors 24 formed in the bottom 21. The support members 31 include lower portions 311 that have feet 312 formed at the ends of the lower portions 311. The anchors 24 connect the plurality of support members 31 to the base pan 20 by defining locations for the feet 312 of the support members 31 to be snapped into the base pan 20. In particular, the foot 312 of each of the support members 31 includes a resilient tab 313 extending from one side of the foot 312. When the support member 31 is installed on the base pan 20, the resilient tab 313 is engaged against the respective anchor 24 and bent inwardly as the foot 312 is inserted between the anchor 24 and the upstanding rim 22 of the base pan 20, such that the foot 312 becomes “snapped” into place between the respective anchor 24 and the upstanding rim 22 as the foot 312 is brought into engagement with the bottom 21 of the base pan 20. Accordingly, the lower portion 311 of the support member 31 is retained between the respective anchor 24 and the upstanding rim 22 of the base pan 20.

According to one example, the anchors 24 are arranged in the base pan 20 to define indexed positions for the plurality of support members 31 in the base pan 20. According to another example, the support members 31 may have numbered slots along their length to identify equipment bracket location positioning.

According to one example of the present disclosure, the support members 31 and the pieces 33, 34 of the top rail 32 of the frame assembly 30 are manufactured via injection molding and/or extrusion processes from a polymeric material, in particular a combination of virgin and regrind ABS material. As discussed above, the support members 31 and the pieces 33, 34 of the top rail 32 are manufactured to be an exact fit with each other and with the base pan 20 such that the support members 31 and the pieces 33, 34 may be assembled with each other and with the base pan 20 in a snap-together manner with no separate fasteners or with a minimal number of separate fasteners being required and also with no jigs.

It is to be appreciated that by manufacturing the base pan 20 and the frame assembly 30 from polymeric material, the spa assembly 10 is provided with a longer-lasting, more durable construction because the polymeric materials are not subject to rot and degradation over time as wood material may be. Further, the polymeric materials do not require the application of preservatives, stains or paint for protection.

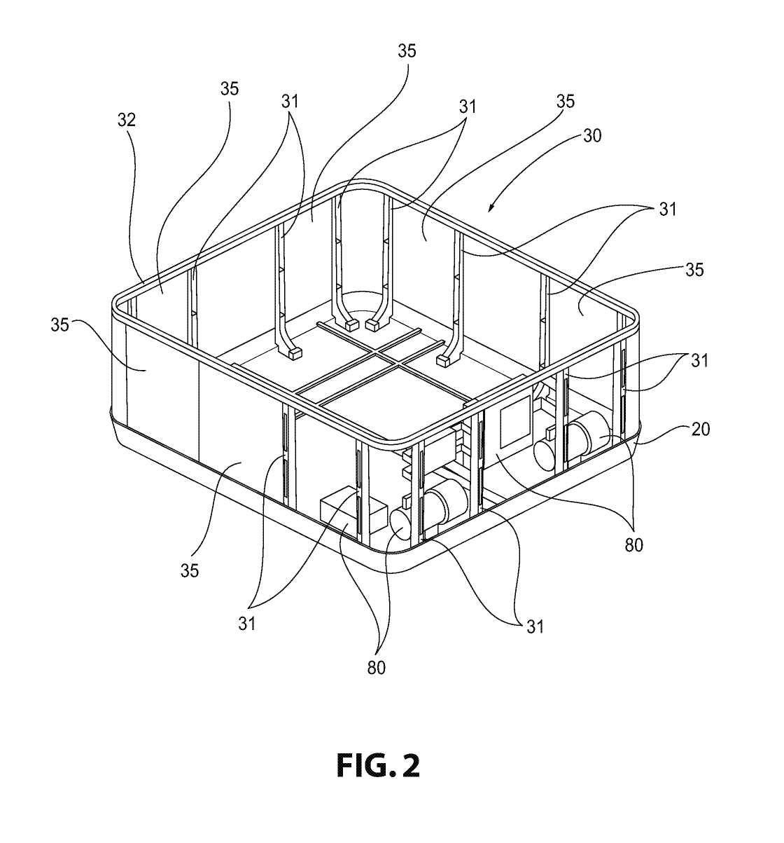

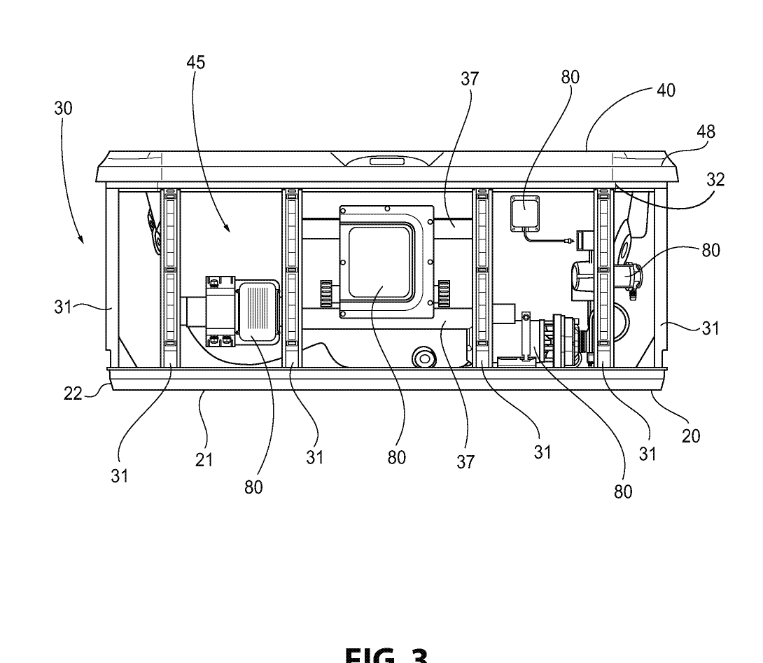

With reference to FIGS. 1-5, 9, and 10, the spa assembly 1 further includes a plurality of spa components and accessories 80, such as pumps, heaters, audio speakers and sub-woofers, control modules, audio modules, and water care modules, or any other components or accessories typically utilized in spa tubs. The base pan 20 and the frame assembly 30 are configured to provide mounting locations for placement of the spa components and accessories 80 within the spa assembly 10. In particular, the base pan 20 is formed with a number of mounting locations 27 therein for the placement of certain spa components and accessories 80 within the base pan 20 between the frame assembly 30 and the spa shell 40. The exact size and configuration of the mounting locations 27 may vary to suit the mounting of different spa components and accessories 80 within the base pan 20. Additionally, as shown in FIGS. 9 and 10, the pieces of the top rail 32 may be formed with a depending vertical flange 39 to allow for various equipment brackets 37 and hooks 38 to be connected to the top rail 32. The brackets 37 and hooks 38 allow for certain spa components and accessories 80 to be mounted at locations along the top rail 32. Further, as shown in FIGS. 2 and 3, other brackets 37 may be connected directly to certain support members 31 to define mounting locations for certain spa components and accessories 80. To that end, according to an example of the present disclosure, the support members 31 may have numbered slots along their length to identify mounting locations for certain spa components and accessories 80. Accordingly, the base pan 20 and the frame assembly 30 are configured to provide fixed mounting locations for the spa components and accessories 80 in a standard equipment layout, which allows for more efficient assembly and field service of the spa assembly 10 since the correct position for individual components is quickly established and predicted. The base pan 20 also eliminates the need to build decking to support the spa components and accessories 80 and protects the spa components and accessories 80 from external environmental conditions. Further, the spa components and accessories 80 can be mounted lower within the spa assembly 10, which allows for more space to be allotted to the seats formed in the spa shell 40,

With reference to FIGS. 1, 11, and 12, according to one example of the present disclosure, the exterior surface 45 of the bottom 41 of the spa shell 40 has a foam material 46 applied to at least a portion of the bottom 41. In particular, the foam material 46 is applied to the exterior surface 45 to the area of a foot well defined in the bottom 41 of the spa shell 40. According to one example of the present disclosure, the foam material 46 is a sprayed polyurethane material, such as polyurethane foam having a 4 lb. density, having a thickness of 1.5″-4.0″ (3.8-6.4 cm). The foam material 46 is applied in a liquid form and then expands and hardens in a manner that is well known to those having ordinary skill in the art. The foam material 46 is machined after application to have interlocking features 47 defined therein, such as recesses, facets, and protrusions. The base pan 20 is formed with corresponding interlocking features 23 configured to engage with the interlocking features 47 of the foam material 46 on the bottom 41 of the spa shell 40. The external shape of the foam material 46 may also serve as an interlocking feature 47 engaging with a corresponding recess in the base pan 20. During assembly of the spa shell 40 on the base pan 20, the interlocking features 47 in the foam material 46 and in the base pan 20 engage with each other to align the spa shell 40 within the base pan 20.

With reference to FIGS. 1, 3, and 11-13, according to an example of the present disclosure, the spa. shell 40 further includes a rim 48 surrounding the at least one side 42. The rim 48 is hollow and defines an internal cavity facing downward. The internal cavity has a foam material 49 applied thereto. The foam material 49 may be the same polyurethane foam material applied to the bottom 41 of the spa shell 40 discussed above. According to one example of the present disclosure, the internal cavity is filled or substantially filled with the foam material 49, i.e., the foam material 49 is applied to the internal cavity to occupy all of or nearly all of the volume of the internal cavity with the foam material 49 extending flush or nearly flush with the bottom edge of the rim, as shown in FIG. 13. The foam material 49 within the rim 48 is machined after application to have a recess 50 defined therein configured to receive a top of the at least one support member therein for engagement and alignment of the spa shell 40 with the at least one support member. More specifically, the foam material 49 applied to the rim 48 has a groove 50 defined therein, which is configured to receive the top rail 32 of the frame assembly 30 to engage and align the spa shell 40 with the frame assembly 30. It is to be appreciated that alternative configurations for establishing a connection between the frame assembly 30 and the rim 48 of the spa shell 40 may be utilized as found to be suitable to those having ordinary skill in the art. For instance, the top rail 32 of the frame assembly 30 may be omitted and the recess 50 may comprise a plurality of holes formed in the foam material 49 configured to receive the top ends of the plurality of support members 31.

It is to be appreciated that the foam material 46 applied to the bottom 41 of the spa shell 40 and the foam material 49 applied to the hollow interior of the rim 48 of the spa shell 40 may be replaced with a different molded or formable material that may be easily shaped to incorporate the interlocking features 47 and the at least one recess or groove 50. For instance, a molded thermoplastic material may be applied to the bottom 41 of the spa shell 40 and to the rim 48, which is shaped prior to or during application to the spa shell 40. Alternatively, the spa shell 40 may be formed such that the interlocking features 47 and the at least one recess or groove 50 are formed directly into the material of the spa shell 40 either during the molding process for the spa shell 40 or during subsequent machining.

Common prior art spa assemblies have poor alignment and offset between the spa shell and the frame assembly/base due, in part, to the lack of structural engagement between the spa shell and the frame assembly/base, to the large assembly variances in the shell and frame systems, and the design differences in siding systems. The engagement between the bottom 41 of the spa shell 40 and the base pan 20 and between the rim 48 of the spa shell 40 and the top rail 32 of the frame assembly 30 aligns and interlocks the spa shell 40 within the base pan 20 and the frame assembly 30. These engagements allow for the spa shell 40 to be more fully supported and integrated with the structure of the base pan 20 and the frame assembly such that deflection, i.e., racking, of the base pan 20 and the frame assembly 30 with respect to the spa shell 40 is limited or eliminated. Further, the stack-up height of the spa shell 40, the frame assembly 30, and the base pan 20 can be made more consistent between individual spa assemblies 10. Additionally, assembly of the spa assembly 10 may be simplified and performed more efficiently because the spa shell 40 will align with the frame assembly 30 and the base pan 20 in only a single position, and the fit between the spa shell 40, the frame assembly 30, and the base pan 20 may be provided with a tighter tolerance.

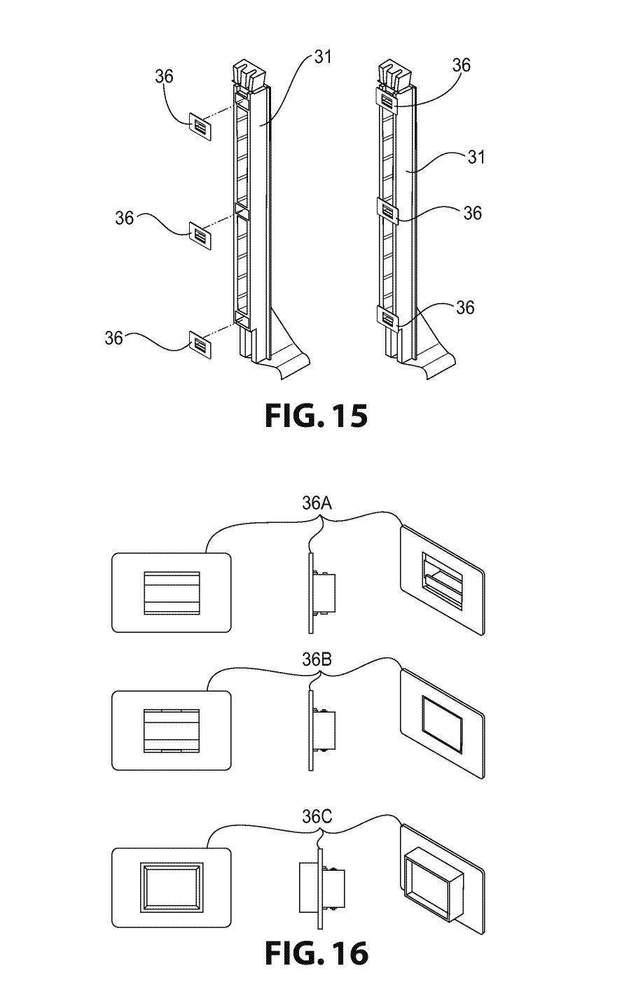

With reference to FIGS. 1, 2 and 14-16, the spa assembly 10 further includes a plurality of insulative panels 35 connected to the frame assembly 30. The insulative panels 35 are connected to the frame assembly 30 around the entire spa assembly 10 to enclose the spa assembly 10 around at least one side 42 of the spa shell 40. In particular, each insulative panel 35 is fastened between two adjacent support members 31 of the frame assembly 30 and extends from the rim 22 of the base pan 20 to the top rail 32 to seal or at least substantially seal the volume of air within the spa assembly 10 between the frame assembly 30 and the exterior surface 45 of the spa shell 40. As shown in FIG. 15, a plurality of clips 36 is provided to fasten the insulative panels 35 to the respective support members 31. The clips 36, which may be in the form of grommets, include features on one side thereof to snap into corresponding recesses defined in the support members 31. The opposite sides of the clips 36 are configured to be engaged by fasteners, such as snap-in fasteners or screws, for securing the spa siding panels (not shown) to the clips 36. In particular, as shown in FIG. 16, the clips 36 may be chosen from a group consisting of: a snap-in receiver 36A, a screw-in receiver 36B, a screw-in receiver 36C that includes a spacer, or various combinations of these examples. According to one example of the present disclosure, the insulative panels 35 are formed from 1.5″ (3.8 cm) rigid foam board having a Mylar® wrap vapor barrier.

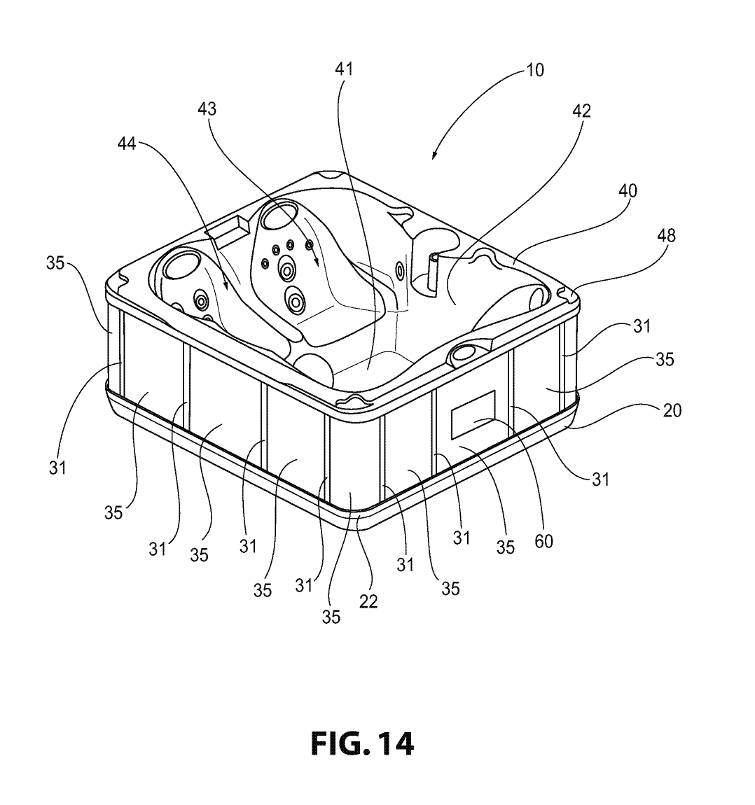

With reference to FIG. 14, the insulative panels 35 create an insulated air space or cavity between the frame assembly 30 and the exterior surface 45 of the spa shell 40. Accordingly, heat generated by the operation of the pumps, heaters, and other components of the spa assembly 10 will be retained within the volume of air within the enclosed spa assembly 10. This retained heat will, in turn, be transferred to the water within the open internal volume 43 of the spa shell 40, which will reduce the need to utilize heaters to condition the temperature of the water. The confined volume of air within the spa assembly 10 also prevents the buildup of environmental contaminants within the spa assembly 10 and maintains cleanliness within the spa assembly 10. The spa assembly 10 may additionally be provided with a ventilation system 60 to exchange the volume of air within the enclosed spa assembly 10 with the exterior of the spa assembly 10. The ventilation system 60 is provided to prevent overheating of the components 80 within the spa assembly 10 by exhausting a certain amount of heated air from within the spa assembly 10 and allowing cooler external air into the spa assembly 10 when the temperature within the spa assembly 10 reaches or goes above a threshold temperature. The ventilation system 60 may be connected to a temperature gauge (not shown) for measuring the temperature within the spa assembly 10 and a controller (not shown) for automatically managing operation of the ventilation system 60. The ventilation system 60 may additionally incorporate air filters for limiting or eliminating the introduction of environmental contaminants into the spa assembly 10.

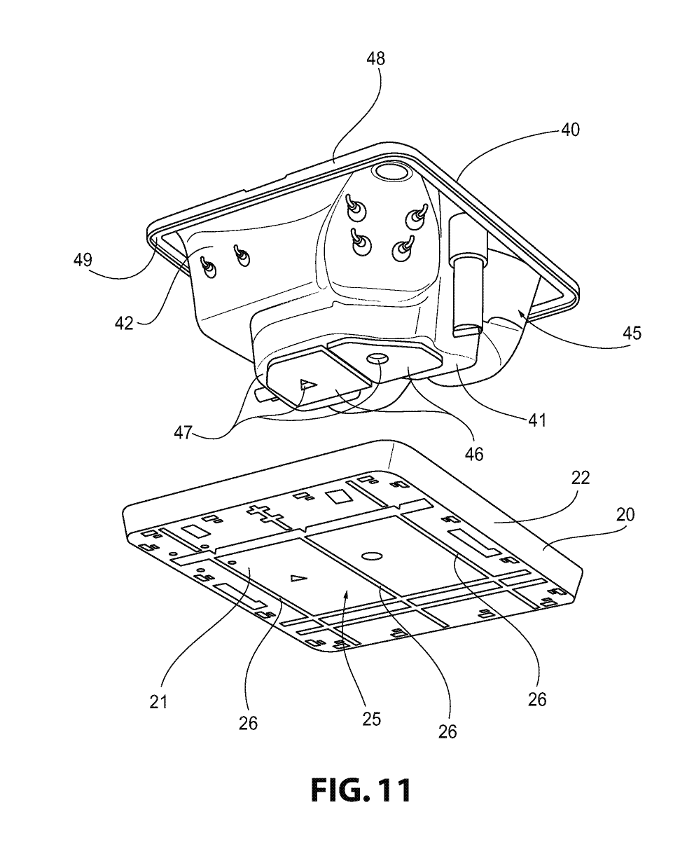

With reference to FIGS. 1 and 11, the spa assembly 10 may include at least one pallet member 70. The bottom surface 25 of the base pan 20, i.e., the surface at the bottom 21 of the base pan 20 oriented away from the spa shell 40 and the frame assembly 30, may have at least one recess 26 formed therein. The recess 26 is configured to receive the at least one pallet member 70 therein. As shown, the spa assembly 10 includes three pallet members 70, and the bottom surface 25 of the base pan 20 includes three corresponding recesses 26. When assembled in the corresponding recesses 26, the pallet members 70 form an integrated pallet to assist in the movement and handling of the spa assembly 10 during manufacturing, shipment, and installation. After installation of the completed spa assembly 10, the pallet members 70 can be removed from the base pan 20 and recycled or disposed. The arrangement of the integrated pallet reduces the costs associated with providing a separate pallet to hold and ship the spa assembly 10.

With reference to FIGS. 1-16, according to one example of the present disclosure, a method of assembling a spa is provided. The method includes providing a base pan 20, at least one support member, such as a support member 31, and a spa shell 40. The base pan 20 includes interlocking features 23. The spa shell 40 includes a bottom 41 and at least one side 42 defining an open internal volume 43 of the spa, an interior surface 44 oriented toward the open internal volume 43, an opposing exterior surface 45, and a rim 48 surrounding the at least one side 42, the rim 48 defining an internal cavity. The method further includes connecting at least one support member 31 to the base pan 20 such that the at least one support member extends upward from the base pan 20; applying a foam material 46 to at least a portion of the exterior surface 45 of the bottom 41 of the spa shell 40; forming interlocking features 47 in the foam material 46 applied to the bottom 41 of the spa shell 40, the interlocking features 47 in the foam material 46 corresponding to the interlocking features 23 of the base pan 20; applying the foam material 49 to the internal cavity of the rim 48; forming a recess 50 in the foam material 49 in the internal cavity of the rim 48; and installing the spa shell 40 on the base pan 20 and the at least one support member 31 such that the spa shell 40 is supported by the base pan 20 and the at least one support member 31. The installing step includes engaging the interlocking features 23 of the base pan 20 with the interlocking features 47 in the foam material 46 applied to the bottom 41 of the spa shell 40 to align the spa shell 40 within the base pan 20 and engaging a top of the at least one support member within the recess 50 in the foam material 49 in the internal cavity of the rim 48.

According to the example, the at least one support member includes a frame assembly 30, and the frame assembly 30 includes a plurality of support members 31 connected to the base pan 20 and a top rail 32 connected to the support members 31 and extending around a perimeter of the spa assembly 10.

The base pan 20 may include a plurality of anchors 24 formed therein. The anchors 24 are configured to connect the plurality of support members 31 to the base pan 20. The anchors 24 are arranged in the base pan to define indexed positions for the plurality of support members 31 in the base pan 20. The method further includes connecting the, plurality of support members 31 to the base pan 20 at the indexed positions.

The step of forming the recess 50 in the foam material 49 in the internal cavity of the rim 48 includes forming a groove 50 in the foam material 49. The step of engaging the top of the at least one support member within the recess 50 in the foam material 49 in the internal cavity of the rim 48 includes engaging the top rail 32 of the frame assembly 30 within the groove 50 in the foam material 49.

The method may further include providing a plurality of insulative panels 35 and enclosing the spa assembly 10 around the at least one side 42 of the spa shell 10 by connecting the plurality of insulative panels 35 to the frame assembly 30.

According to one example of the present disclosure, the entirety of the manufacturing of the spa assembly 10 or substantial portions of the manufacturing of the spa assembly 10 may performed in a mechanized manner by one or more robotic devices. For instance, robotics may be utilized throughout the molding and vacuum forming processes for the spa shell 40, the base pan 20, and the individual pieces of the frame assembly 30. Further, robots may be utilized to apply the foam material 46, 49 to the bottom 41 and the rim 48 of the spa shell 40 and to machine the interlocking features 47 and the recess 50 in the foam material 46, 49. The frame assembly 30 may also be assembled on the base pan 20 by robots. The ability to manufacture the spa assembly 10 through the use of robots serves to reduce the labor costs associated with manufacture of the spa assembly 10 and reduces production errors through the consistent performance of the steps in the manufacturing process. The use of robots in the manufacturing process also reduces material waste in the manufacturing process, since tolerances may be reduced and material variance in the production of the spa assemblies 10 can be reduced or eliminated.

Further examples of the present disclosure will now be described in the following number clauses.

Clause 1: A spa assembly (10), comprising: a base pan (20); at least one support member connected to and extending upward from the base pan (20); and a spa shell (40) supported on the base pan (20) and the at least one support member, the spa shell (40) comprising a bottom (41) and at least one side (42) defining an open internal volume (43) of the spa shell (40), an interior surface (44) oriented toward the open internal volume (43), and an opposing exterior surface (45), wherein the bottom (41) of the spa shell (40) and the base pan (20) comprise corresponding interlocking features (23, 47) configured to align the spa shell (40) within the base pan (20).

Clause 2: The spa assembly (10) according to clause 1, wherein the exterior surface (45) of the bottom (41) of the spa shell (40) has a formable material (46) applied to at least a portion thereof, the interlocking features (47) being formed in the formable material (46).

Clause 3: The spa assembly (10) according to clause 2, wherein the formable material comprises a foam material (46).

Clause 4: The spa assembly (10) according to any one of clauses 1-3, wherein the spa shell (40) further comprises a rim (48) surrounding the at least one side (42), and wherein the rim (48) has a recess (50) formed therein, the recess (50) being configured to receive a top of the at least one support member.

Clause 5: The spa assembly (10) according to clause 4, wherein the rim (48) defines an internal cavity having a formable material (49) applied thereto, the recess (50) being defined in the formable material (49).

Clause 6: The spa assembly (10) according to clause 5, wherein the formable material comprises a foam material (49).

Clause 7: The spa assembly (10) according to any one of clauses 1-6, wherein the at least one support member comprises a frame assembly (30), the frame assembly (30) comprising: a plurality of support members (31) connected to the base pan (20); and a top rail (32) connected to the support members (31) and extending around a perimeter of the spa assembly (10).

Clause 8: The spa assembly (10) according to clause 7, wherein the base pan (20) comprises a plurality of anchors (24) formed therein, the anchors (24) being configured to connect the plurality of support members (31) to the base pan (20), and wherein the anchors (24) are arranged in the base pan (20) to define indexed positions for the plurality of support members (31) in the base pan (20).

Clause 9: The spa assembly (10) according to clause 8, wherein each of the plurality of support members (31) comprises a lower portion (311) with a foot (312) defined at an end thereof, wherein the foot (312) of each of the plurality of support members (31) comprises a resilient tab (313) extending therefrom, and wherein the resilient tab (313) is configured to engage a respective one of the anchors (24) in the base pan (20) to retain the lower portion (311) between the anchor (24) and an upstanding rim (22) of the base pan (20).

Clause 10: The spa assembly (10) according to any one of clauses 7-9, wherein the spa shell (40) further comprises a rim (48) surrounding the at least one side (42), and wherein the rim (48) has a groove (50) formed therein, the groove (50) being configured to receive the top rail (32) therein.

Clause 11: The spa assembly (10) according to any one of clauses 7-10, wherein the top rail (32) comprises an assembly of interconnected rail pieces (33, 34).

Clause 12: The spa assembly (10) according to any one of clauses 7-11, wherein a plurality of insulative panels (35) is connected to the frame assembly (30) and the plurality of insulative panels (35) encloses the spa assembly (10) around the at least one side (42) of the spa shell (10).

Clause 13: The spa assembly (10) according to clause 12, wherein the frame assembly (30) comprises a plurality of clips (36) configured to connect the plurality of insulative, panels (35) to the plurality of support members (31).

Clause 14: The spa assembly (10) according to clause 12 or 13, further comprising a ventilation system (60) configured to exchange a volume of air within the enclosed spa assembly (10) with an exterior of the spa assembly (10).

Clause 15: The spa assembly (10) according to any one of clauses 1-14, further comprising at least one pallet member (70), wherein a bottom surface (25) of the base pan (20) has at least one recess (26) formed therein, the at least one recess (26) being configured to receive the at least one pallet member (70) therein.

Clause 16: The spa assembly (10) according to any one of clauses 1-15, further comprising a plurality of spa components and accessories (80), wherein the base pan (20) and the at least one support member are configured to provide mounting locations for placement of the plurality of spa components and accessories (80).

Clause 17: A spa assembly (10), comprising: a base pan (20); at least one support member connected to and extending upward from the base pan (20); and a spa shell (40) supported on the base pan (20) and the at least one support member, the spa shell (40) comprising a bottom (41) and at least one side (42) defining an open internal volume (43) of the spa shell (40), an interior surface (44) oriented toward the open internal volume (43), an opposing exterior surface (45), and a rim (48) surrounding the at least one side (42), wherein the rim (48) has a recess (50) formed therein, the recess (50) being configured to receive a top of the at least one support member.

Clause 18: The spa assembly (10) according to clause 17, wherein the rim (48) defines an internal cavity having a formable material (49) applied thereto, the recess (50) being defined in the formable material (49).

Clause 19: The spa assembly (10) according to clause 18, wherein the formable material comprises a foam material (49).

Clause 20: The spa assembly (10) according to any one of clauses 17-19, wherein the bottom (45) of the spa shell (40) and the base pan (20) comprise corresponding interlocking features (23, 47) configured to align the spa shell (40) within the base pan (20).

Clause 21: The spa assembly (10) according to any one of clauses 17-20, wherein the at least one support member comprises a frame assembly (30), the frame assembly (30) comprising: a plurality of support members (31) connected to the base pan (20); and a top rail (32) connected to the support members (31) and extending around a perimeter of the spa assembly (10).

Clause 22: The spa assembly (10) according to clause 21, wherein the recess (50) in the rim (48) comprises a groove (50), the groove (50) being configured to receive the top rail (32) therein.

Clause 23: A spa assembly (10), comprising: a base pan (20); a frame assembly (30), the frame assembly (30) comprising: a plurality of support members (31) connected to the base pan (20); and a top rail (32) connected to the support members (31) and extending around a perimeter of the spa assembly (10); a spa shell (40) supported on the base pan (20) and the frame assembly (30), the spa shell (40) comprising a bottom (41) and at least one side (42) defining an open internal volume (43) of the spa shell (40), an interior surface (44) oriented toward the open internal volume (43), and an opposing exterior surface (45); a plurality of insulative panels (35) connected to the frame assembly (30), wherein the plurality of insulative panels (35) encloses the spa assembly (10) around the at least one side (42) of the spa shell (40); and a plurality of clips (36) configured to connect the plurality of insulative panels (35) to the plurality of support members (31).

Clause 24: The spa assembly (10) according to clause 23, wherein the bottom (41) of the spa shell (40) and the base pan (20) comprise corresponding interlocking features (23, 47) configured to align the spa shell (40) within the base pan (20).

Clause 25: Thu spa assembly (10) according to clause 23 or 24, wherein the spa shell (40) further comprises a rim (48) surrounding the at least one side (42), and wherein the rim (48) has a groove (50) formed therein, the groove (50) being configured to receive the top rail (32) therein.

Clause 26: A spa assembly (10), comprising: a base pan (20): at least one support member connected to and extending upward from the base pan (20); a spa shell (40) supported on the base pan (20) and the at least one support member, the spa shell (40) comprising a bottom (41) and at least one side (42) defining an open internal volume (43) of the spa shell (40), an interior surface (44) oriented toward the open internal volume (43), and an opposing exterior surface (45); and at least one pallet member (70), wherein a bottom surface (25) of the base pan (20) has at least one recess (26) formed therein, the at least one recess (26) being configured to receive the at least one pallet member (70) therein.

Clause 27: The spa assembly (10) according to clause 26, wherein the bottom (41) of the spa shell (40) and the base pan (20) comprise corresponding interlocking features (23, 47) configured to align the spa shell (40) within the base pan (40).

Clause 28: The spa assembly (10) according to clause 26 or 27, wherein the at least one support member comprises a frame assembly (30), the frame assembly (30) comprising: a plurality of support members (31) connected to the base pan (20); and a top rail (32) connected to the support members (31) and extending around a perimeter of the spa assembly (10).

Clause 29: The spa assembly (10) according to clause 28, wherein the spa shell (40) further comprises a rim (48) surrounding the at least one side (42), and wherein the rim (48) has a groove (50) formed therein, the groove (50) being configured to receive the top rail (32) therein.

Clause 30: The spa assembly (10) according to clause 28 or 29, wherein a plurality of insulative panels (35) are connected to the frame assembly (30) and the plurality of insulative panels (35) enclose the spa assembly around the at least one side (42) of the spa shell (40).

Clause 31: A method of assembling a spa (10), comprising: providing a base pan (20), at least one support member, and a spa shell (40), wherein the base pan (20) comprises interlocking features (23) and the spa shell (40) comprises a bottom (41) and at least one side (42) defining an open internal volume (43) of the spa shell (40), an interior surface (44) oriented toward the open internal volume (43), an opposing exterior surface (45), and a rim (48) surrounding the at least one side (42), the rim (48) defining an internal cavity; connecting the at least one support member to the base pan (20) such that the at least one support member extends upward from the base pan (20); applying a foam material (46) to at least a portion of the exterior surface (45) of the bottom (41) of the spa shell (40); forming interlocking features (47) in the foam material (46) applied to the bottom (41) of the spa shell (40), the interlocking features (47) in the foam material (46) corresponding to the interlocking features (23) of the base pan (20); applying a foam material (49) to the internal cavity defined by the rim (48); forming a recess (50) in the foam material (49) in the internal cavity of the rim (48); and installing the spa shell (40) on the base pan (20) and the at least one support member such that the spa shell (40) is supported by the base pan (20) and the at least one support member, wherein the installing step comprises engaging the interlocking features (23) of the base pan (20) with the interlocking features (47) in the foam material (46) applied to the bottom (45) of the spa shell (40) to align the spa shell (40) within the base pan (20) and engaging a top of the at least one support member within the recess (50) in the foam material (49) in the internal cavity of the rim (48).

Clause 32: The method according to clause 31, wherein the at least one support member comprises a frame assembly (30), the frame assembly (30) comprising: a plurality of support members (31) connected to the base pan (20); and a top rail (32) connected to the support members (31) and extending around a perimeter of the spa (10).

Clause 33: The method according to clause 32, wherein the base pan (20) comprises a plurality of anchors (24) formed therein, the anchors (24) being configured to connect the plurality of support members (31) to the base pan (20), and wherein the anchors (24) are arranged in the base pan (20) to define indexed positions for the plurality of support members (31) in the base pan (20), and wherein the method further comprises connecting the plurality of support members (31) to the base pan (20) at the indexed positions.

Clause 34: The method according to clause 32 or 33, wherein the step of forming a recess (50) in the foam material (49) in the internal cavity of the rim (48) comprises forming a groove (50) in the foam material (49), and wherein the step of engaging the top of the at least one support member within the recess (50) in the foam material (49) in the internal cavity of the rim (48) comprises engaging the top rail (32) of the frame assembly (30) within the groove (50) in the foam material (49).

Clause 35: The method according to any one of clauses 32-34, further comprising: providing a plurality of insulative panels (35); and enclosing the spa (10) around the at least one side (42) of the spa shell (40) by connecting the plurality of insulative panels (35) to the frame assembly (30).

It is to be understood that the invention may assume various alternative variations and step sequences, except where expressly specified to the contrary. It is also to be understood that the specific devices and processes illustrated in the attached drawings, and described in the specification, are simply exemplary embodiments or aspects of the invention. Although the invention has been described in detail for the purpose of illustration based on what is currently considered to be the most practical and preferred embodiments or aspects, it is to be understood that such detail is solely for that purpose and that the invention is not limited to the disclosed embodiments or aspects, but, on the contrary, is intended to cover modifications and equivalent arrangements that are within the spirit and scope thereof. For example, it is to be understood that the present invention contemplates that, to the extent possible, one or more features of any embodiment or aspect can be combined with one or more features of any other embodiment or aspect.

The invention claimed is:

1. A spa assembly, comprising:
a base pan;
at least one support member connected to and extending upward from the base pan; and
a spa shell supported on the base pan and the at least one support member, the spa shell comprising a bottom and at least one side defining an open internal volume of the spa shell, an interior surface oriented toward the open internal volume, and an opposing exterior surface,
wherein the bottom of the spa shell and the base pan comprise corresponding interlocking features configured to align the spa shell within the base pan.

2. The spa assembly according claim 1, wherein the exterior surface of the bottom of the spa shell has a formable material applied to at least a portion thereof, the interlocking features being formed in the formable material.

3. The spa assembly according to claim 2, wherein the formable material comprises a foam material.

4. The spa assembly according to claim 1,
wherein the spa shell further comprises a rim surrounding the at least one side, the rim, and
wherein the rim has a recess formed therein, the recess being configured to receive a top of the at least one support member.

5. The spa assembly according to claim 4, wherein the rim defines an internal cavity having a formable material applied thereto, the recess being defined in the formable material.

6. The spa assembly according to claim 5, wherein the formable mat comprises a foam material.

7. The spa assembly according to claim 1, wherein the at least one support member comprises a frame assembly, the frame assembly comprising:
a plurality of support members connected to the base pan; and
a top rail connected to the support members and extending around a perimeter of the spa assembly.

8. The spa assembly according to claim 7, wherein the base pan comprises a. plurality of anchors formed therein, the anchors being configured to connect the plurality of support members to the base pan, and wherein the anchors are arranged in the base pan to define indexed positions for the plurality of support members in the base pan.

9. The spa assembly according to claim 8, wherein each of the plurality of support members comprises a lower portion with a foot defined at an end thereof,
wherein the foot of each of the plurality of support member comprises a resilient tab extending therefrom, and
wherein the resilient tab is configured to engage a respective one of the anchors in the base pan to retain the lower portion between the anchor and an upstanding rim of the base pan.

10. The spa assembly according to claim 7, wherein the spa shell further comprises a rim surrounding the at least one side, and
wherein the rim has a groove formed therein, the groove being configured to receive the top rail therein.

11. The spa assembly according to claim 7, wherein the top rail comprises an assembly of interconnected rail pieces.

12. The spa assembly according to claim 7, wherein a plurality of insulative panels is connected to the frame assembly and the plurality of insulative panels encloses the spa assembly around the at least one side of the spa shell.

13. The spa assembly according to claim 12, wherein the frame assembly comprises a plurality of clips configured to connect the plurality of insulative panels to the plurality of support members.

14. The spa assembly according to claim 12, further comprising a ventilation system configured to exchange a volume of air within the enclosed spa assembly with an exterior of the spa assembly.

15. The spa assembly according to claim 1, further comprising at least one pallet member,
wherein a bottom surface of the base pan has at least one recess formed therein, the at least one recess being configured to receive the at least one pallet member therein.

16. The spa assembly according to claim 1, further comprising a plurality of spa components and accessories, wherein the base pan and the at least one support member are configured to provide mounting locations for placement of the plurality of spa components and accessories.

17. A spa assembly, comprising:
a base pan;
at least one support member connected to and extending upward from the base pan; and
a spa shell supported on the base pan and the at least one support member, the spa shell comprising a bottom and at least one side defining an open internal volume of the spa shell, an interior surface oriented toward the open internal volume, an opposing exterior surface, and a rim surrounding the at least one side, the rim defining an internal cavity having a foam material applied thereto,
wherein the rim has a recess formed therein, the recess being configured to receive a top of the at least one support member.

18. The spa assembly according to claim 17, wherein the rim defines an internal cavity having a formable material applied thereto, the recess being defined in the formable material.

19. The spa assembly according to claim 18, wherein the formable material comprises a foam material.

20. The spa assembly according to claim 12, wherein the bottom of the spa shell and the base pan comprise corresponding interlocking features configured to align the spa shell within the base pan.

21. The spa assembly according to claim 17, wherein the at least one support member comprises a frame assembly, the frame assembly comprising:
a plurality of support members connected to the base pan; and
a top rail connected to the support members and extending around a perimeter of the spa assembly.

22. The spa assembly according to claim 21, wherein the recess in the rim comprises a groove, the groove being configured to receive the top rail therein.

23. A spa assembly, comprising:
a base pan;
a frame assembly, the frame assembly comprising:
a plurality of support members connected to the base pan; and
a top rail connected to the support members and extending around a perimeter of the spa assembly;
a spa shell supported on the base pan and the frame assembly, the spa shell comprising a bottom and at least one side defining an open internal volume of the spa shell, an interior surface oriented toward the open internal volume, and an opposing exterior surface;
a plurality of insulative panels connected to the frame assembly, wherein the plurality of insulative panels encloses the spa assembly around the at least one side of the spa shell; and
a plurality of clips configured to connect the plurality of insulative panels to the plurality of support members.

24. The spa assembly according to claim 23, wherein the bottom of the spa shell and the base pan comprise corresponding interlocking features configured to align the spa shell within the base pan.

25. The spa assembly according to claim 23, wherein the spa shell further comprises a rim surrounding the at least one side, and
wherein the rim has a groove formed therein, the groove being configured to receive the top rail therein.

26. A spa assembly, comprising:
a base pan;
at least one support member connected to and extending upward from the base pan;
a spa shell supported on the base pan and the at least one support member, the spa shell comprising a bottom and at least one side defining an open internal volume of the spa shell, an interior surface oriented toward the open internal volume, and an opposing exterior surface; and
at least one pallet member,
wherein a bottom surface of the base pan has at least one recess formed therein, the at least one recess being configured to receive the at least one pallet member therein.

27. The spa assembly according to claim 26, wherein the bottom of the spa shell and the base pan comprise corresponding interlocking features configured to align the spa shell within the base pan.

28. The spa assembly according to claim 26, wherein the at least one support member comprises a frame assembly, the frame assembly comprising:
a plurality of support embers connected to the base pan; and
a top rail connected to the support members and extending around a perimeter of the spa assembly.

29. The spa assembly according to claim 28, wherein the spa shell further comprises a rim surrounding the at least one side, and
wherein the rim has a groove formed therein, the groove being configured to receive the top rail therein.

30. The spa assembly according to claim 28, wherein a plurality of insulative panels is connected to the frame assembly and the plurality of insulative panels encloses the spa assembly around the at least one side of the spa shell.

31. A method of assembling a spa, comprising:
providing a base pan, at least one support member, and a spa shell, wherein the base pan comprises interlocking features and the spa shell comprises a bottom and at least one side defining an open internal volume of the spa shell, an interior surface oriented toward the open internal volume, an opposing exterior surface, and a rim surrounding the at least one side, the rim defining an internal cavity;
connecting the at least one support member to the base pan such that the at least one support member extends upward from the base pan;
applying a foam material to at least a portion of the exterior surface of the bottom of the spa shell;
forming interlocking features in the foam material applied to the bottom of the spa shell, the interlocking features in the foam material corresponding to the interlocking features of the base pan;
applying a foam material to the internal cavity defined by the
forming a recess in the foam material in the internal cavity of the rim; and
installing the spa shell on the base pan and the at least one support member such that the spa shell is supported by the base pan and the at least one support member,
wherein the installing step comprises engaging the interlocking features of the base pan with the interlocking features in the foam material applied to the bottom of the spa shell to align the spa shell within the base pan and engaging a top of the at least one support member within the recess in the foam material in the internal cavity of the rim.

32. The method according to claim 31, wherein the at least one support member comprises a frame assembly, the frame assembly comprising:
a plurality of support members connected to the base pan; and
a top rail connected to the support members and extending around a perimeter of the spa.

33. The method according to claim 32, wherein the base pan comprises a plurality of anchors formed therein, the anchors being configured to connect the plurality of support members to the base pan, and wherein the anchors are arranged in the base pan to define indexed positions for the plurality of support members in the base pan, and
wherein the method further comprises connecting the plurality of support members to the base pan at the indexed positions.

34. The method according to claim 32, wherein the step of forming a recess in the foam material in the internal cavity of the rim comprises forming a groove in the foam material, and
wherein the step of engaging the top of the at least one support member within the recess in the foam material in the internal cavity of the rim comprises engaging the top rail of the frame assembly within the groove in the foam material.

35. The method according to claim 32, further comprising:
providing a plurality of insulative panels; and
enclosing the spa around the at least one side of the spa shell by connecting the plurality of insulative panels to the frame assembly.
